(19) United States
(12) Patent Application Publication
(10) Pub. No.: US 2004/0139190 A1
(43) Pub. Date: Jul. 15, 2004

(54) A PRIVATE HTTP BASED SYSTEM FOR DIAGNOSIS, CONTROL AND MONITORING OF AN IMAGING SYSTEM CONTROLLER

(76) Inventors: Kevin Scott Kreger, Milwaukee, WI (US); Thomas William Wright, Wales, WI (US); Joseph James Chianese, Brookfield, WI (US); Mohamed El-Demerdash, Milwaukee, WI (US)

Correspondence Address: ARTZ & ARTZ, P.C., 28333 TELEGRAPH RD., SUITE 250, SOUTHFIELD, MI, 48034, US

(21) Appl. No.: 10/248,377

(22) Filed: Jan. 15, 2003

(51) Int. Cl. G06F 15/173

(52) U.S. Cl. 709/224

(57) ABSTRACT

A local private network includes a chassis including a diskless, real-time based board including a memory. The memory downloads an executable program that runs in response to a form output, the memory further downloads a webserver. A host computer electrically coupled to the chassis through an Ethernet connection contains the form, the webserver, and the executable program.

### BACKGROUND OF INVENTION

The present invention relates generally to computer networks and more particularly to a network based system for diagnosis, control, and monitoring of a multiprocessor embedded system for medical imaging.

Imaging devices, such as x-ray and magnetic resonance machines, are widely used in both medical and industrial applications. Monitoring and control of scanning devices has historically been provided by user interfaces designed and implemented by programmers, e.g. embedded or application programmers. These interfaces enable the user to run diagnostics and tools as well as to prescribe and to execute scans.

Non-graphical interfaces (i.e. text or ASCII based) are typically implemented by embedded programmers for use by other programmers and engineers. These interfaces allow functionality tests of lower level drivers and diagnostics and also allow viewing and modification of locations in the microprocessor memory.

To develop these tools into something easily usable to the non-programmer involves an applications programmer creating an associated graphical user interface (GUI). So the production of a diagnostic or tool, useful for the end user, has historically been a two-step process between the embedded programmer and the applications programmer (who writes the GUI). This is both expensive and time consuming.

Additionally, the GUI usually required that the user be physically present at the scanner host computer, which can also be both expensive and time consuming.

The disadvantages associated with current, interface systems have made it apparent that a new technique for interfacing and networking is needed. The new technique should minimize tool development time and should not require that the user be physically present at the host computer. The present invention is directed to these ends.

### SUMMARY OF INVENTION

In accordance with one aspect of the present invention, a local private network includes a chassis including a first diskless, real-time based board including a first memory. The first memory is adapted to download a first executable program adapted to run in response to a first form output. The form output goes across an ethernet connection to the webserver, which then passes on the data to the executable. The first memory is further adapted to download a first webserver. A host computer, electrically coupled to the chassis, is adapted to contain the first form, the first webserver, and the first executable program for downloading.

In accordance with another aspect of the present invention, a method for operating a HyperText Transfer Protocol based system, including a real-time board, includes downloading a first webserver to the real-time board. The webserver is then run as a task. A first executable program is downloaded to the real-time board and run in response to a form and a signal from the webserver.

One advantage of the present invention is easy prototyping of the user interface with HyperText Markup Language (HTML) forms (text based monitor interfaces are eliminated). This shortens the test and debug cycles. Engineers can resultantly create web pages for their most frequently used debug and testing activities at a faster rate.

An additional advantage is that the traditional login and command entry process is replaced with the HTML form. Furthermore, the HTML form is usually self-explanatory, which eliminates any special instructions, which usually accompany the use of a text- based monitor. In general, it is easier to do exhaustive testing with the web form as the user quickly changes several different input parameters before submitting the form. This generates cost savings.

In summary, the web form based approach to developing the MGD/Excite system saves a significant amount time in the development cycle as well as the manufacturing environment. The present invention is an interface that is flexible, easy to understand, easy to use, less error-prone, and allows quick and exhaustive tests than current prior art systems.

Additional advantages and features of the present invention will become apparent from the description that follows and may be realized by the instrumentalities and combinations particularly pointed out in the appended claims, taken in conjunction with the accompanying drawings.

### BRIEF DESCRIPTION OF DRAWINGS

For a more complete understanding of the invention, there will now be described some embodiments thereof, given by way of example, reference being made to the accompanying drawings, in which:

FIG. 1 is a diagram of an imaging system in accordance with one embodiment of the present invention;

FIG. 2 is a schematic diagram of the imaging system of FIG. 1; and

FIG. 3 is a block diagram of a method for operating a HyperText Transfer Protocol based system in accordance with another embodiment of the present invention.

### DETAILED DESCRIPTION

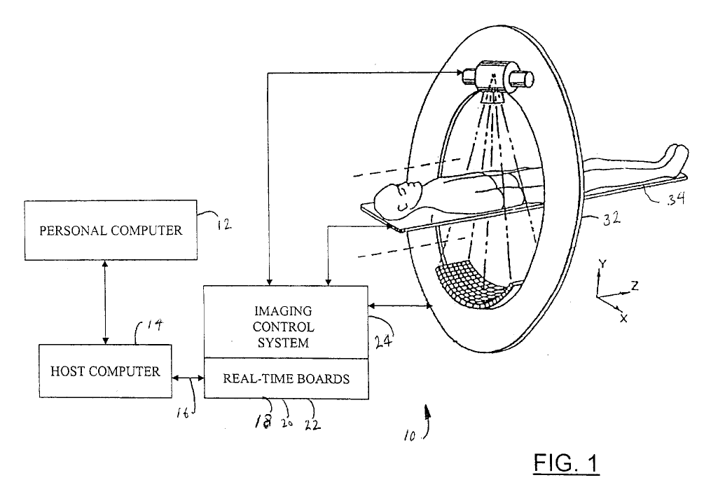

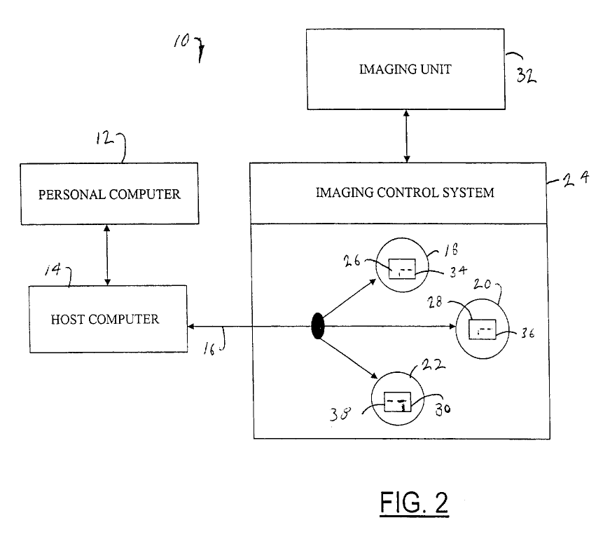

The present invention is illustrated with respect to a local private network 10 including a private, HyperText Transfer Protocol (HTTP) based system for diagnosis, control, and monitoring of a multiprocessor embedded system for medical imaging, particularly suited to the medical field. The present invention is, however, applicable to various other uses that may require private, HyperText Transfer Protocol based systems, as will be understood by one skilled in the art. Referring to FIGS. 1 and 2, the local private network 10, including a personal computer 12 coupled to a host computer 14, is illustrated. The host computer 14 is coupled, through an Ethernet 16 connection, to real-time boards 18, 20, 22 within an imaging control system 24. For one embodiment, three real-time boards 18, 20, 22 all running webservers 34 (or alternatively webservers 34, 36, 38) inside the imaging control system 24 (chassis), are illustrated. The memories 26, 28, 30 of the real-time boards 18, 20, 22 contain executable programs that are run by using forms on the host computer 14. The imaging control system 24 is electrically coupled to an imaging unit 32, in accordance with one embodiment of the present invention.

The personal computer 12 coupled to the host computer 14 is illustrated and will be discussed in detail in relation to the other components of the system 10. The host computer 12 is coupled, through the Ethernet connection 16, to real-time boards 18, 20, 22 within the imaging control system 24 (chassis).

First, second, and third real-time boards 18, 20, 22 are illustrated running webservers inside the imaging control system 24. The first board 18 contains a first memory 26, the second board 20 contains a second memory 22 and the third board 22 contains a third memory 30. Important to note is that the present invention includes embodiments having one, two, three or more real-time boards, each having at least one memory.

The memories 26, 28, 30 are standard RAM memories or any other known memory units suitable for storing the webserver 34. The boards 18, 20, 22 are diskless systems requiring that the server 34 and the associated Common Gateway Interface (CGI) executables be loaded from an external computer (host computer 14) via the Ethernet connection 16.

The webserver 34 (or alternately 34, 36, 38), which, in one embodiment, is used on the first, second and third real-time component boards 18, 20, 22 of the imaging control system 24, enables the execution of any functions on the processor boards 18, 20, 22 from the web browser. The webserver 34 runs on various known real-time operating systems.

The webserver 34 is also embedded in the memories 26, 28, 30 of real-time based boards 18, 20, 22. “Embedded in the memory”signifies that the program is downloaded and run as a task.

One embodiment of the webserver 34 does not serve static HTML pages but is used to run CGI executables. These executables are also embedded in the board memories 26, 28, 30.

The webserver 34 is used to service requests to perform some utility or diagnostic on the system. In other words, it serves only as a control and status interface. The webserver 34 direct usage is limited to the local private network 10. This is generally not a tool for use on the World Wide Web (as are almost all other webservers). The webserver HTTP/CGI interface adds another layer of industry standard communication interface capability to the network system 10.

HTTP/HTML and associated CGI is currently a common (industry standard) user interface that runs in a web browser (i.e. Netscape Navigator, and Internet Explorer to name the two most popular). This user interface is usually referred to as a web-based form and has several easy-to-use input features such as radio buttons, check boxes, and text boxes.

The HTML pages used to access the webserver 34 are stored on the host computer 14. The host computer is connected (i.e. networked via Ethernet 16 connections) to the imaging control system 36 containing the real-time boards. This is novel since typical servers have their pages resident on the same system that serves the HTTP requests. Alternately, these HTML pages may also reside on the personal computer 12.

Prototyping of the user interface (personal computer 12) with HTML forms is simplified through the present invention (text based monitor interfaces are eliminated). Resultantly, the test and debug cycle are shortened.

The traditional login and command entry process is also replaced with the HTML form, which is usually self-explanatory. The self-explanatory form eliminates any special instructions, which usually accompany the use of a text-based monitor.

In general, it is easier to do exhaustive testing with the web form as the user can quickly change several different input parameters before submitting the form.

Engineers test new functions easily in the absence of a defined product user interface. The methods for invoking these new functions are embedded in the HTML form and associated CGI executable. This information is then being provided, in one embodiment, to the host programmers for creating the end product user interface.

HTML pages are used to prototype new features and then are distributed to sites for clinical evaluation. This generates early user feedback on user interface issues and feature reliability. This also minimizes the amount of work required to clinically evaluate new features.

An additional feature of the present invention is that Unix based scripts (such as PERL) access the system using HTTP calls to mine data and observe trends. Logs of HTTP requests are automatically generated therefrom.

The memories 26, 28, 30 of the real-time boards 18, 20, 22 contain executable programs that are run by using forms on the host computer 14. The forms may be invoked by running a web browser locally or remotely over a private local network or dial up connection (by the remote user on the personal computer 12).

A user at the personal computer 12 runs functions using the web browser remotely on any computer that is networked to the imaging control system 24 (i.e. the host computer 14 is not needed to support this interface and the forms are available on the personal computer 12 as noted above). This remote capability potentially shortens development time and allows ease of access for remote users.

A user (including a non-programmer) generates the forms using several known graphical oriented tools. Since the code that services the form is built into the web browser, there is no need to write or compile code for the user interface. This presents the embedded programmer (and the non-programmer) with an opportunity to create a simple and easy to use form, which alternately also contains instructions detailing form usage. Furthermore, this form runs on almost any platform (PC, SGI, etc.) either locally or remotely. This approach requires that the real-time processor boards 18, 20, 22 (which run medical imaging systems) have a program running (i.e.

HTTP server), which takes the CGI requests generated by the form and invokes the associated functions in an imaging control system 24.

The imaging control system 24 is electrically coupled to an imaging unit 32 in accordance with one embodiment of the present invention. In the present embodiment, the imaging control system 24 contains the real-time boards 18, 20, 22.

The imaging control system 24 also includes various components, such as x-ray control, table control, and data acquisition, as will be understood by one skilled in the art.

The present invention is illustrated with respect to an imaging control system 24 and imaging unit 32, this includes any type of imaging system, including magnetic resonance imaging (MRI), mammography, vascular x-ray imaging, bone scanning, PET, radionuclide imaging, ultrasound imaging, optical imaging, etc. Further embodiments include non-medical applications, such as weld inspection and metal inspection.

Applications that do not require the scanner interface could replace the standard host computer 14 with a less expensive computer, for example, a standard PC running Linux could be used in the hardware testing station of the imaging control system in the absence of a complete scanner.

The present invention is adapted for use with any real-time system that has the capability to run a webserver. One embodiment includes a diskless system that utilizes the VxWorks operating system with the GoAhead realwebserver. This approach is used for producing user interfaces to run diagnostics. All monitoring activities for certain known systems are also coded as HTML forms which are organized in a single easy to use page. These pages have been internally reused for automated test on the manufacturing floor and are being provided to board manufactures for their testing requirements.

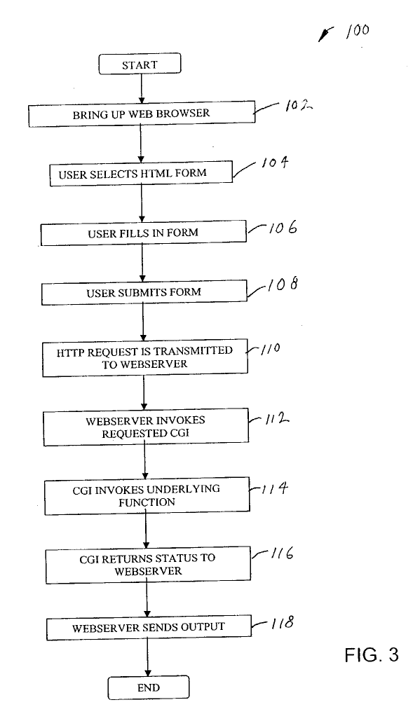

Referring to FIG. 3, a block diagram of a method 100 for operating a HyperText Transfer Protocol based system is illustrated. Logic starts in operation block 102 where an HTTP request is made to bring up the web browser either locally on the host computer or remotely on the PC, i.e. the user starts the web browser.

In operation block 104, the user selects an HTML form to run a desired diagnostic/tool. In operation block 106, the user fills in form, and in operation block 108, the user submits form. In operation block 110, the http request is transmitted to appropriate webserver. In operation block 112, the webserver invokes requested CGI. In operation block 114, the CGI invokes the underlying function(s) to engage the requested status/control. In operation block 116, the CGI returns the status to webserver. In operation block 118, the webserver sends an output response to the user browser, which could be a plot, a value, or something as simple as a pass/fail (ok or error).

In operation, a method for operating a HyperText Transfer Protocol based system including a real-time board includes downloading a first webserver to the real-time board. The webserver is then run as a task. A first executable program is downloaded to the real-time board and run in response to a form and a signal from the webserver.

From the foregoing, it can be seen that there has been brought to the art a new local private network 10. It is to be understood that the preceding description of the preferred embodiment is merely illustrative of some of the many specific embodiments that represent applications of the principles of the present invention. Numerous and other arrangements would be evident to those skilled in the art without departing from the scope of the invention as defined by the following claims.

In the claims:

1. A local private network comprising:
a chassis comprising a first diskless, real-time based board comprising a first memory,
said first memory adapted to download a first executable program adapted to run in response to a first form output, said first memory further adapted to download a first webserver; and
a host computer electrically coupled to said chassis, said host computer adapted to contain said first form output, said first webserver, and said first executable program.

2. The network of claim 1 wherein said chassis further comprises a second diskless real-time based board comprising a second memory; and
said second memory adapted to download a second executable program adapted to run in response to a second form.

3. The network of claim 1 wherein said first webserver is adapted to run CGI executables.

4. The network of claim 3 wherein said CGI executables are embedded in said first memory.

5. The network of claim 1 wherein said first webserver is adapted to perform as a control and status interface.

6. The network of claim 1 wherein direct usage of said first webserver is limited to a local private network.

7. The network of claim 1 wherein said first webserver is used on a real-time component board of a medical imaging system.

8. The network of claim 1 wherein a HTML page used to access said first webserver is stored on said host computer.

9. The network of claim 1 wherein said first form output is run through operating a web browser locally or remotely.

10. A method for operating a HyperText Transfer Protocol based system including a real-time board comprising:
downloading a first webserver to the real-time board;
running said webserver as a task;
downloading a first executable program to the real-time board; and
running said first executable program in response to a form and a signal from said webserver.

11. The method of claim 10 wherein running said webserver as a task further comprises servicing a request to run a utility or diagnostic on the system.

12. A local private network comprising:
a chassis comprising a first diskless, real-time based board comprising a first memory, said chassis further comprising a second diskless real-time based board comprising a second memory;
said first memory adapted to download a first executable program adapted to run in response to a first form output, said first memory further adapted to download a first webserver;
said second memory adapted to download a second executable program adapted to run in response to a second form output, said first memory further adapted to download said first webserver; and
a host computer coupled to said chassis through an Ethernet connection, said host computer adapted to contain said first form output, said second form output, said first webserver, a mechanism to access said first webserver, said first executable program and said second executable program.

13. The network of claim 12 wherein said first webserver is adapted to run CGI executables embedded in said board memory.

14. The network of claim 12 wherein said first webserver is adapted to perform as a control and status interface.

15. The network of claim 12 wherein direct usage of said first webserver is limited to a local private network.

16. The network of claim 12 wherein said first webserver is used on a real-time component board of a medical imaging system.

17. The network of claim 12 wherein a HTML page used to access said first webserver is stored on said host computer.

18. The network of claim 12 wherein said first form output is run through operating a web browser locally or remotely.

19. The network of claim 18 wherein said mechanism to access said first webserver comprises at least one HTML page.

20. The network of claim 18 wherein said chassis is a component of an imaging system.
